(19) United States
(12) Patent Application Publication
(10) Pub. No.: US 2026/0271820 A1
(43) Pub. Date: Sep. 17, 2026

(54) DISTINGUISHING HEADLAND AND IN-FIELD PASSES TO GENERATE A PATH PLAN OF A MACHINE

(71) Applicant: Deere & Company, Moline, IL (US)

(72) Inventors: Amey G. Katti, Pune (IN); Shashank S. Karkare, Pune (IN); Sagar H. Tambe, Pune (IN)

(21) Appl. No.: 19/080,084

(22) Filed: Mar. 14, 2025

(51) Int. Cl. A01B 69/04

(52) U.S. Cl. CPC A01B 69/008

(57) ABSTRACT

Obtaining positions of an agricultural machine along a path of travel of the agricultural machine within a field. Determining whether each of the positions is a headland position or an in-field position based upon whether each of the positions is located within a headland of the field. Identifying passes of the agricultural machine within the field along the path of travel. Determining whether each of the passes is a headland pass or an in-field pass based upon the headland positions and the in-field positions. Deriving a map based upon the passes. The map includes the passes and each of the passes is identified as a headland pass or an in-field pass.

### TECHNICAL FIELD

This disclosure relates generally to agricultural machines, and more particularly, to distinguishing headland and in-field passes of an agricultural machine in a field.

### BACKGROUND

Traditional agricultural machines may rely heavily on operator input for control. The operator may be required to constantly monitor various factors, such as terrain conditions, weather, and crop conditions, to maintain safe and efficient operation of agricultural machines. To illustrate, a harvester (i.e., a harvesting machine) may be controlled by an operator to harvest crops by making consecutive passes through a field. The operator may guide the harvester to ensure that such consecutive passes at least partially overlap to ensure all crops are effectively harvested. Moreover, the operator may guide the harvester between such consecutive passes by effectively turning the harvester when a pass is completed so that the harvester is properly aligned to complete a subsequent pass.

Guidance systems may be implemented in agricultural machines to decrease the operator input needed to guide the agricultural machines. Such guidance systems may utilize one or more sensors of the agricultural machines to monitor movement of the agricultural machines. For example, the agricultural machines may include one or more sensors that monitor the ground speed and/or position of the agricultural machines to ensure the speed and/or the position of the agricultural machines is within an acceptable range. Due at least in part to such guidance systems, agricultural machines may operate substantially or entirely autonomously without the need for operator input (e.g., without manual speed control and/or steering by the operator).

### SUMMARY

In one aspect of the present disclosure, a method is disclosed. The method includes obtaining positions of an agricultural machine along a path of travel of the agricultural machine within a field. The method further includes determining whether each of the positions is a headland position or an in-field position based on whether each of the positions is located within a headland of the field. The method also includes identifying passes of the agricultural machine within the field along the path of travel. Additionally, the method includes determining whether each of the passes is a headland pass or an in-field pass based upon the headland positions and the in-field positions and deriving a map based upon the passes. The map includes the passes and each of the passes is identified as a headland pass or an in-field pass.

In certain configurations, a position may be determined to be a headland position if the position is located within the headland. The position may be determined to be an in-field position if the position is located outside of the headland and within an in-field region. The in-field region may be located adjacent to the headland.

In certain configurations, identifying the headland of the field may include defining a perimeter of the field and defining a perimeter of an in-field region within the field. The headland may be an area located between the perimeter of the field and the perimeter of the in-field region.

In certain configurations, determining whether each of the passes is a headland pass or an in-field pass may include comparing a number of headland positions of each of the passes to a threshold. Each of the passes may be determined to be a headland pass if the number of headland positions exceeds the threshold.

In certain configurations, the positions may be obtained based upon a first agricultural machine traversing the path of travel. Additionally, the method may further include deriving a path plan for a second agricultural machine based on the map. The method may also include determining turn paths between the passes, whereby the path plan may be based on the map and the turn paths.

In certain configurations, the agricultural machine may include an implement. Identifying the passes may be based upon determining when the implement is operating. The identified passes may correspond to discrete portions of the path of travel that are traversed by the agricultural machine when the implement is operating. Additionally, the identified passes may be separated by discrete portions of the path of the path of travel that are traversed by the agricultural machine when the implement is not operating.

In another aspect of the present disclosure, a system is disclosed. The system includes one or more memories and one or more processors that are configured to execute instructions stored in the one or more memories. The one or more processors are configured to execute instructions stored in the one or more memories to obtain positions of an agricultural machine along a path of travel of the agricultural machine within a field. The one or more processors are further configured to execute instructions stored in the one or more memories to determine whether each of the positions is a headland position or an in-field position based on whether each of the positions is located within a headland of the field, identify passes of the agricultural machine within the field along the path of travel, and determine whether each of the passes is a headland pass or an in-field pass based upon the headland positions and the in-field positions. The one or more processors are further configured to execute instructions stored in the one or more memories to derive a map based upon the passes. The map includes the passes and each of the passes is identified as a headland pass or an in-field pass.

In certain configurations, a position may be determined to be a headland position if the position is located within the headland and the position may be determined to be an in-field position if the position is located outside of the headland and within an in-field region. The in-field region may be located adjacent to the headland.

In certain configurations, the instructions to identify a headland of the field may include instructions to define a perimeter of the field and define a perimeter of an in-field region within the field. The headland area may be located between the perimeter of the field and the perimeter of the in-field region.

In certain configurations, the instructions to determine whether each of the passes is a headland pass or an in-field pass may include instructions to compare a number of headland positions of each of the passes to a threshold. Each of the passes may be determined to be a headland pass if the number of headland positions exceeds the threshold.

In certain configurations, the positions may be obtained based upon a first agricultural machine traversing the path of travel. Additionally, the one or more processors may be further configured to execute instructions stored in the one or more memories to derive a path plan for a second agricultural machine based on the map. The one or more processors may also be configured to determine turn paths between the passes. The path plan may be based on the map and the turn paths.

In certain configurations, the agricultural machine may include an implement. The passes may be identified based upon determining when the implement is operating. The identified passes may correspond to discrete portions of the path of travel that are traversed by the agricultural machine when the implement is operating. Moreover, the identified passes may be separated by discrete portions of the path of the path of travel that are traversed by the agricultural machine when the implement is not operating.

In another aspect of the present disclosure, one or more non-transitory computer readable media storing instructions operable to cause one or more processors to perform operations is disclosed. The operations include obtaining positions of an agricultural machine along a path of travel of the agricultural machine within a field. The operations further includes determining whether each of the positions is a headland position or an in-field position based on whether each of the positions is located within a headland of the field, identifying passes of the agricultural machine within the field along the path of travel, and determining whether each of the passes is a headland pass or an in-field pass based upon the headland positions and the in-field positions. The operations also include deriving a map based upon the passes. The map includes the passes and each of the passes is identified as a headland pass or an in-field pass.

In certain configurations, a position may be determined to be a headland position if the position is located within the headland and the position may be determined to be an in-field position if the position is located outside of the headland and within an in-field region. The in-field region may be located adjacent to the headland.

In certain configurations, determining whether each of the passes is a headland pass or an in-field pass may include comparing a number of headland positions of each of the passes to a threshold. Each of the passes may be determined to be a headland pass if the number of headland positions exceeds the threshold.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a side view of an example of an agriculture machine that includes a guidance system.

FIG. 1B is a top-down view of the agriculture machine shown in FIG. 1A.

FIG. 2 is a block diagram of a system for setting an agricultural machine path plan.

FIG. 3A illustrates an example of a path plan for an agriculture machine.

FIG. 3B illustrates determining a turn path between passes within the path plan of the agriculture machine.

FIG. 4 is an example of a computing device.

FIG. 5 is a flowchart of an example of a technique for deriving a map based on a position of an agriculture machine.

FIG. 6 is a flowchart of an example of a technique for deriving a map based on identified passes of an agriculture machine along a path of travel of the agriculture machine.

FIG. 7 is a flowchart of an example of a technique for navigating a second agricultural machine according to a path plan derived from a map that is based on operation of a first agricultural machine.

FIG. 8 is a flowchart of an example of a technique for deriving a map based on a position of an agriculture machine.

### DETAILED DESCRIPTION

Farming technologies are known and used for generating path plans for machines based on the initial path of a machine (i.e., a first machine). A path plan, in the context of farming and agricultural machinery, is a pre-defined route or set of guidance lines that directs the movements of farming equipment across a field. A path plan ensures that various agricultural operations, such as planting, fertilizing, spraying, and harvesting, are carried out in an organized and efficient manner. For example, the lines (e.g., the passes) driven by a planter can be used to generate corresponding guidance lines for each row unit, which are then used to guide subsequent machines like sprayers and harvesters. Such generated corresponding guidance lines can also be used to guide the planter during future operations. To illustrate, assume a field where a planter has sown seeds in 24-row sections, Global Positioning System (GPS) data from this planting operation can be used to create a path plan for subsequent machines, such as a sprayer or a combine harvester. For example, the sprayer may follow the same 24-row sections, and the combine harvester, which can handle 12 rows at a time, may follow a path plan that directs it to harvest in two passes for each 12-row section planted.

Typically, the path plan may be generated to maximize productivity of the agricultural machinery and minimize resource expenditure. For example, traditional agricultural machinery operations may often involve an operator that manually operates (e.g., drives, controls, etc.) the agricultural machinery along a series of generally parallel passes within an in-field region of a field (e.g., a region of the field containing the crop). These passes are commonly referred to as “in-field passes.” To transition between these in-field passes, the operator may execute turns at the end of each in-field pass. These turns may often be performed in the unworked area surrounding the in-field, commonly referred to as a “headland area” or a “headland.” The headland may extend between the in-field and an outer perimeter of the field forming at least a partial border around the in-field. As such, the in-field may be located adjacent to the headland.

In some circumstances, the path plan may include one or more passes (e.g., a series of generally parallel passes) that are located substantially or entirely within the headland. These passes are commonly referred to as “headland passes.” The headland passes may be oriented relative to the in-field passes to facilitate navigation along the perimeter of the in-field. For example, the agricultural machinery may be configured to travel along a series of headland passes to define the perimeter of the in-field. By way of example, when the agricultural machinery traverses the headland passes, the terrain within the headland may be substantially flattened by the agricultural machinery to clearly define the perimeter of the in-field. During such traversal of the headland passes, the agricultural machinery may also be configured to clear unwanted vegetation or growth (e.g., trees, grass, etc.) that may cause irregularities in the terrain, thereby further defining the perimeter of the in-field and providing a smooth region in which agricultural machinery may turn between the in-field passes.

Autonomous guidance for the agricultural machinery (e.g., the planter, sprayer, harvester, etc.) may involve controlling a speed and/or a position of the machinery during operation using a guidance system of the agricultural machinery. For example, the guidance system, or a system in communication with the guidance system (e.g., a path planning system) may generate a path plan for an agricultural machine (e.g., a planter, a sprayer, a harvester, etc.) such as those described above. The path plan may include guidance lines or paths, which may be in-field passes and/or headland passes, for the agricultural machine to follow such that the guidance system may guide the agricultural machine along these passes at a controlled speed.

Additionally, the guidance system may be configured to automate turns of the agricultural machine. For example, the path plan may include planned turns to connect in-field passes and/or headland passes so that the agricultural machine may be guided by the guidance system continuously along the passes and between the passes. In other words, the guidance system may navigate the agricultural machine through any number of passes by automating turns between passes, thereby enhancing the level of automation of the agricultural machine and minimizing or even eliminating user input.

Conventional guidance systems for agricultural machinery may be unable to discern between the in-field passes and the headland passes. That is, the path plan may include any number of generic passes without distinguishing between the passes that are located within the in-field and the passes that are located within the headland (i.e., without distinguishing between the in-field passes and the headland passes). Thus, in the generated path plan, in-field passes may be inadvertently connected to headland passes, and vice versa. In other words, the generated turns may improperly connect an in-field passe and a headland passe to one another, thereby creating an inefficient and/or undesirable path plan. As a result, the in-field may be ineffectively traversed or a portion of the in-field may be entirely missed because the agricultural machine may be caused to exit the in-field prematurely or skip portions of the in-field entirely when following these improper connections, thereby resulting in inconsistent care (e.g., planting, cultivating, fertilizing, harvesting, etc.) of the in-field.

Implementations according to this disclosure solve problems such as these by distinguishing between in-field passes and headland passes when generating path plans. By identifying the in-field passes and the headland passes as different types of passes, a path plan is generated to include automated turns that properly connect the series of in-field passes and/or which connect the series of headland passes. As such, the agricultural machine may be prevented from prematurely exiting the in-field prior to completing its task and/or skipping portions of the in-field entirely due to following improper connections between passes.

To describe some implementations in greater detail, reference is first made to examples of systems, machines, implements, hardware, and software structures used to implement a system for generating a path plan for agricultural machinery.

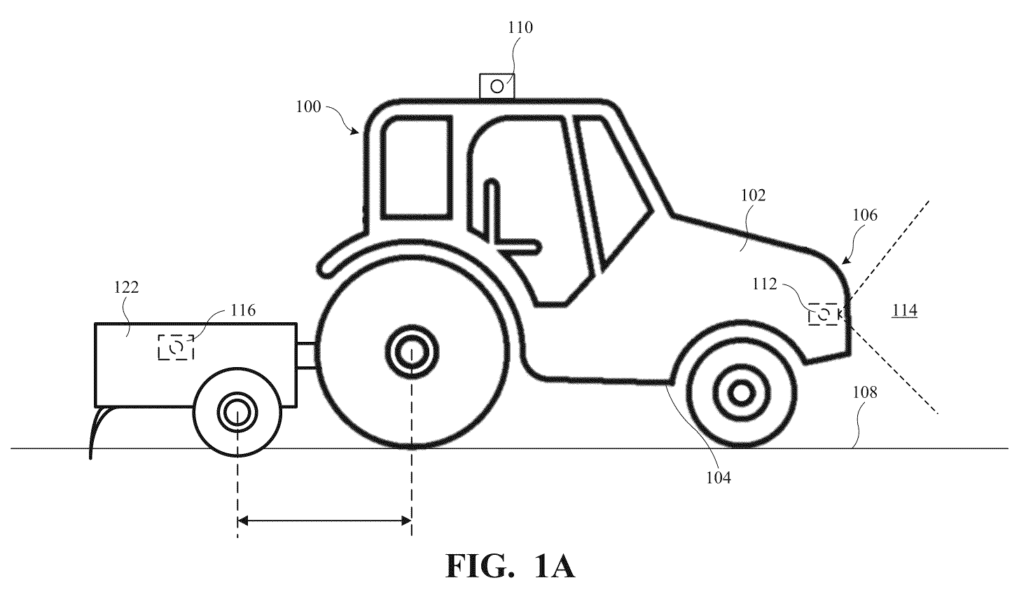

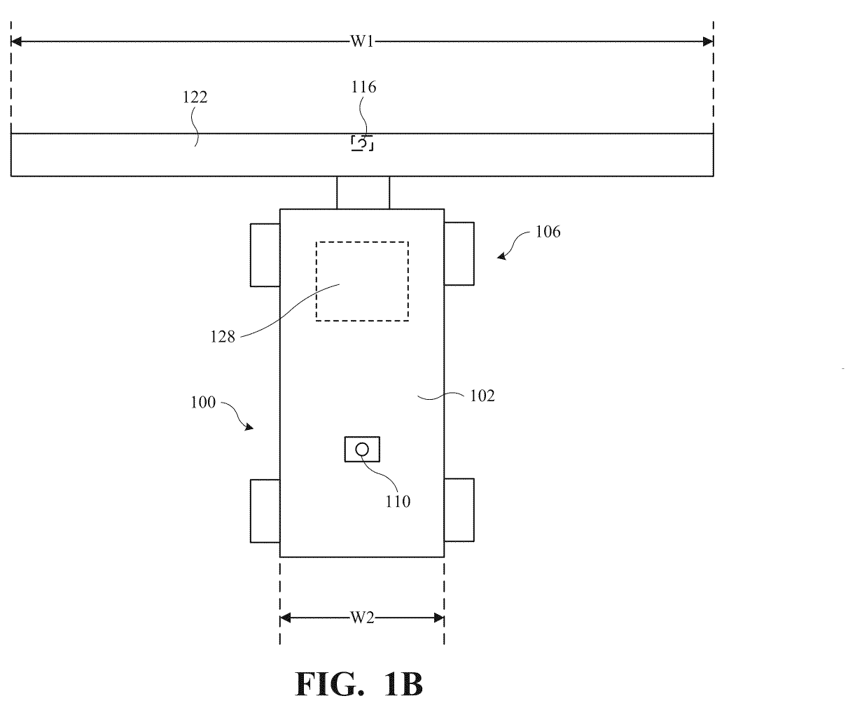

Turning now to the figures, FIGS. 1A and 1B illustrate a side view and a top-down view, respectively, of an agricultural machine 100. The agricultural machine 100 may include a body 102 and a frame 104. The frame 104 may form part of the body 102 or may support the body 102 of the agricultural machine 100. Additionally, the agricultural machine 100 may include a guidance system 106, such as those described herein. For example, the guidance system 106 may be or may include one or more GPS units, to determine a geographic location of the agricultural machine 100. The agricultural machine 100 is not limited to any specific type of machinery. For example, the agricultural machine 100 may be a vehicle, equipment, other object, or a combination thereof. The agricultural machine 100 may be configured for any type of operation in the agriculture industry. However, the agricultural machine 100 is not particularly limited to agriculture, and may be suitable for any type of industry, such as horticulture or other types of industry.

As shown in FIGS. 1A and 1B, the agricultural machine 100 may be a tractor that is configured to traverse a terrain 108 to apply one or more products (e.g., fertilizer, nutrients, fungicide, pesticide, etc.) to crops or a combine configured to harvest the crops. In some configurations, the agricultural machine 100 may be remotely and/or autonomously operated (e.g., via the guidance system 106 of the agricultural machine 100) such that an operator need not be present at the location of the agricultural machine 100.

The guidance system 106 may be coupled to or part of the agricultural machine 100 so that one or more sensors of the guidance system 106, such as a first sensor 110 and a second sensor 112, may be positioned to monitor or otherwise obtain data associated with operation of the agricultural machine 100. For example, the first sensor 110 may be coupled (e.g., connected, mounted, secured, etc.) to the body 102 or the frame 104, such as along a roof of the agricultural machine 100. The second sensor 112 may also be coupled to the body 102 or the frame 104 such that a field of view 114 (e.g., a field of view of a lens of the second sensor 112) may extend outboard with respect to the agricultural machine 100 in front of the agricultural machine 100 (e.g., in a forward direction of travel of the agricultural machine 100).

Alternatively, or additionally, the guidance system 106 may be coupled to an accessory or secondary component of the agricultural machine 100. For example, as shown in FIGS. 1A and 1B, the guidance system 106 may include a third sensor 116 coupled to an implement 122 of the agricultural machine 100. The implement 122 may be connected to the agricultural machine 100 so that the implement 122 may, for example, be towed or pushed by the agricultural machine 100. For example, the implement 122 may be an applicator that is configured to apply water, nutrients, fertilizer, pesticides, fungicides, or a combination thereof to the crops. Alternatively, the implement 122 may be a cultivator that is configured to harvest the crops based upon travel of the agricultural machine 100 across the terrain 108.

It should be noted that the guidance system 106 may include any number of sensors (e.g., zero or more of the first sensor 110, zero or more of the second sensor 112, zero or more of the third sensor 116, etc.) and may be positioned in any desired manner by adjusting the mounting of the guidance system 106 to the agricultural machine 100 and/or to the implement 122. Thus, an overall field of view, which may include the field of view 114 of the second sensor 112 and/or additional fields of view of sensors within the guidance system 106, may be configured to capture any desired region(s) around the agricultural machine 100, which may include parts or components of the agricultural machine 100 and/or the implement 122, surrounding crops, the terrain 108 surrounding the agricultural machine 100 and/or the implement 122, or a combination thereof. Additionally, adjusting the mounting of the guidance system 106 may ensure accurate sensor data. For example, the first sensor 110 may be mounted externally to the body 102 of the agricultural machine 100 to ensure that communication between the first sensor 110 and an external device (e.g., a computer, tablet, satellite, etc.) is unobstructed by the agricultural machine 100.

By way of example, the agricultural machine 100 may be coupled to the implement 122 to guide (e.g., control) the implement 122, whereby the implement 122 may be a harvester configured to harvest existing crops within a field. In this configuration, the guidance system 106 may be integrated into the agricultural machine 100 and/or the implement 122 so that the first sensor 110, the second sensor 112 (e.g., the field of view 114 of the second sensor 112), and the third sensor 116 can monitor a position of the agricultural machine 100 and/or the implement 122 as the agricultural machine 100 traverses the terrain 108.

Additionally, the guidance system 106 may be coupled to the agricultural machine 100 and/or the implement 122 so that the field of view 114 of the second sensor 112 can monitor the area (including the terrain 108) ahead of the agricultural machine 100 and the implement 122. Furthermore, the sensors (e.g., the first sensor 110, the second sensor 112, and the third sensor 116) may be positioned to monitor various environment-related parameters (e.g., sensor data associated with the terrain 108, associated with other objects in the area around the agricultural machine 100 and/or the implement 122, etc.) and/or monitor operation of the agricultural machine 100 (e.g., sensor data associated with the operation of the agricultural machine 100). The sensors may thus capture the sensor data associated with the environment, the agricultural machine 100, the implement 122, or a combination thereof. The sensor data may then be processed by the guidance system 106 (e.g., by a control module 128 therein) to determine a position of the agricultural machine 100 and/or the implement 122. The sensor data may further be processed to determine or predict a path of travel (e.g., predict a pass) of the agricultural machine 100.

For example, the sensors may capture the sensor data associated with the agricultural machine 100 and the guidance system 106 may analyze the captured sensor data to determine a position and/or speed of the agricultural machine 100. Similarly, the sensors may capture the sensor data associated with the implement 122 and the guidance system 106 may analyze the captured sensor data to determine a position and/or speed of the implement 122. The guidance system 106 or a system in communication with the guidance system (e.g., a system located in wireless communication with guidance system 106) may then combine and/or capture the determined position and/or speed of the agricultural machine 100 with the determined position and/or speed of the implement 122 to determine a relative position and/or speed of the implement 122 with respect to the agricultural machine 100. As a result, the guidance system 106 may provide a more accurate determination of the path of the implement 122 with respect to the agricultural machine 100 to identify drift of the implement 122 (e.g., deviation of the implement 122 from the path of travel of the agricultural machine 100), which may be caused by changes in the terrain 108 and/or environmental conditions (e.g., rain, snow, ice, wind, etc.)

In some implementations, the implement 122 may have a width (W1) that is greater than or less than a width (W2) of the agricultural machine 100. Similarly, the implement 122 may be configured to adjust its width (W1) to accommodate various crop widths. As described above, the implement 122 may be a harvester that is configured to harvest existing crops within a field. The width (W1) of the implement 122 (e.g., as measured transverse to the direction of travel of the agricultural machine 100) may be adjusted (e.g., increased or decreased) based upon a row width of the existing crops within the field such that the implement 122 extends to or beyond the row width of the existing crops to effectively harvest the crops. In such a case, the third sensor 116 may capture data associated with adjusting the width (W1) of the implement 122.

The captured data may then be evaluated by the guidance system 106. For example, the captured data may be initially transmitted from the third sensor 116 to the control module 128 of the guidance system 106. The control module 128 may then evaluate the captured data, including the width (W1) of the implement 122, to determine whether the implement 122 has deviated from the path of travel of the agricultural machine 100.

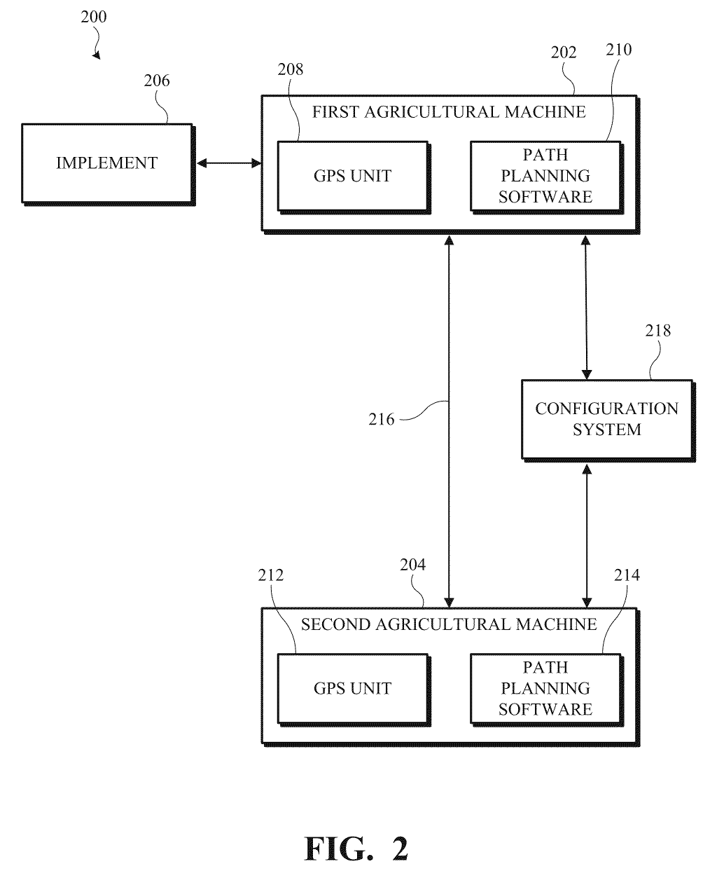

FIG. 2 is a block diagram of a system 200 for setting a path plan based on an initial path of travel completed by a first agricultural machine 202. The path plan may be set for subsequent operation of the first agricultural machine 202 and/or subsequent operations of additional agricultural machines, such as a second agricultural machine 204. For illustrative purposes, the system 200 may include the first agricultural machine 202 and the second agricultural machine 204. However, the system 200 is not particularly limited to the first agricultural machine 202 and the second agricultural machine 204 and may include any number of agricultural machines.

The first agricultural machine 202 can be a harvester (e.g., a combine harvester, a forage harvester, a sugar can harvester, etc.) or any other type of agricultural machine. For example, the first agricultural machine 202 may be, or may be similar to, the agricultural machine 100 shown in FIGS. 1A and 1B. In an example, the first agricultural machine 202 may be a tractor towing an implement 206. The implement 206 may be a grain cart, a harvester, or multiple carts. By way of example, the implement 206 may be similar to the implement 122 shown in FIGS. 1A and 1B. In an example, the implement 206 may be a harvester towed by the first agricultural machine 202 (e.g., the tractor).

The second agricultural machine 204 can be any type of machine that traverses a field based upon an initial traversal of the field by the first agricultural machine 202. That is, the first agricultural machine 202 may be configured to complete an initial traversal of the field, whereby the path plan may be set based on the initial traversal of the field by the first agricultural machine 202. The second agricultural machine 204 may then subsequently traverse the field based on the path plan. By way of example, the second agricultural machine 204 may be an applicator, a cultivator, a planter, or any other type of agricultural machine.

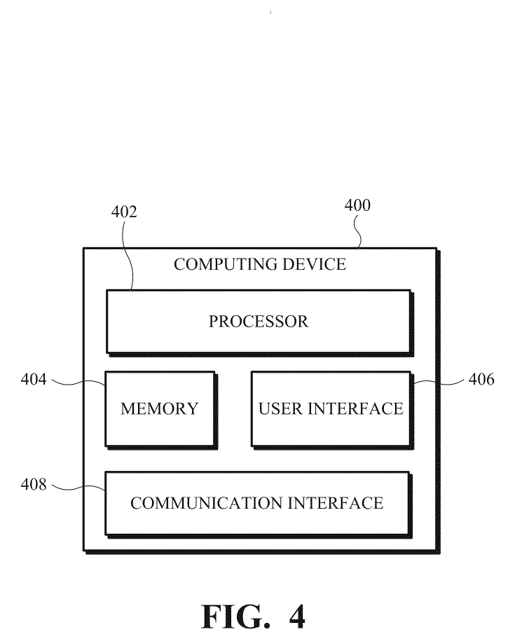

For simplicity, this disclosure uses statements such as “agricultural machine X performs an action Y.” These statements should be understood to mean that a computing device (e.g., a controller) within agricultural machine X performs the action Y or executes instructions to cause agricultural machine X to perform the action Y. A software application, which is executable by the computing device and may be included in or work in conjunction with agricultural machine X, can also perform action Y or cause agricultural machine X to perform action Y. The computing device may be as described with respect to FIG. 4.

The first agricultural machine 202 is shown as including a GPS unit 208 and a path planning software 210. In some implementations, the first agricultural machine 202 may not include the path planning software 210. The second agricultural machine 204 is shown as including a GPS unit 212 and a path planning software 214. A GPS unit can be used to determine the precise geographic location of the respective agricultural machine by receiving signals from multiple GPS satellites and calculating the agricultural machine’s position based on the time relay of the received signals. Alternatively, other positioning technologies such as Real-Time Kinematic (RTK) GPS, Radio Frequency Identification (RFID), Bluetooth Low Energy (BLE) beacons, Differential GPS (DGPS), and Long-Range Navigation (Loran) may be used to accomplish the same purpose.

The path planning software 210 can be used to obtain (e.g., identify, select, or receive) a path plan (e.g., a set of guidance lines, which may correspond to a set of passes within a field) that first agricultural machine 202 is to traverse over within the field. The path planning software 214 can be used to derive (identify, calculate, or receive) a path plan for the second agricultural machine 204 based on the path plan of the first agricultural machine 202. The path plan of the second agricultural machine 204 may be the same as the path plan of the first agricultural machine 202 or the path plan of the second agricultural machine 204 may be derived from the path plan of the first agricultural machine 202. For example, the second agricultural machine 204 may exhibit different operating constraints compared to the first agricultural machine 202 (e.g., a different turn radius, speed limitations, etc.). As a result, the path plan of the first agricultural machine 202 may be adjusted to establish the path plan of the second agricultural machine 204 and take into account the different operating constraints of the second agricultural machine 204.

As discussed above, the path plan of the first agricultural machine 202 may be based on an initial traversal of the field by the first agricultural machine 202. In some implementations, the path plan of the first agricultural machine 202 may be based on an initial traversal of the field by another agricultural machine (e.g., other than the first agricultural machine 202 and the second agricultural machine 204) prior to operation of the first agricultural machine 202. This initial traversal provides the foundational data for creating an accurate path plan for the first agricultural machine 202. A path plan of the implement 206 (referred to herein as the “implement path plan”) may follow the path plan of the first agricultural machine 202 or may be obtained from the path plan of the first agricultural machine 202. For example, the implement path plan may be at a constant offset form the path plan of the first agricultural machine 202 due to coupling (e.g., connection) of the implement 206 to the first agricultural machine 202 as the first agricultural machine 202 traverses the field and pulls the implement 206 through the field. The path plan of second agricultural machine 204, on the other hand, can follow the path plan of the first agricultural machine 202 during a subsequent traversal of the field.

The GPS unit 208 can be used to track the geographic location of the first agricultural machine 202 during an initial traversal of the field and thereby determine the path plan of the first agricultural machine 202. For example, the GPS unit 208 may, in real-time, obtain the geographic location of the first agricultural machine 202 along its initial path of travel to obtain a set of location data points of the first agricultural machine 202, which may then be mapped to determine the initial path of travel of the first agricultural machine 202. Based on the initial path of travel, the path plan may be set for subsequent traversals of the field by the first agricultural machine 202. During such subsequent traversals of the field, the GPS unit 208 may monitor the geographic position of the first agricultural machine 202 to ensure that the first agricultural machine 202 follows the set path plan.

Similarly, the GPS unit 212 can be used to track the geographic location of the second agricultural machine 204. For example, the GPS unit 212 may, in real-time, obtain the geographic location of the second agricultural machine 204 when the second agricultural machine 204 traverses the field based on the path plan for the second agricultural machine 204. As discussed above, the path plan of the second agricultural machine 204 may be based on the path plan of the first agricultural machine 202. During traversal of the field based on the path plan for the second agricultural machine 204, the GPS unit 212 may monitor the geographic position of the second agricultural machine 204 to ensure that the second agricultural machine 204 follows the set path plan.

Each of the path planning software 210 and the path planning software 214 can be or include programs, subprograms, functions, routines, subroutines, operations, executable instructions, and/or the like for, inter alia and as further described herein, setting path plans for the first agricultural machine 202 and/or the second agricultural machine 204, which may be based on map derived from an initial traversal of a field by the first agricultural machine 202. The path planning software 210 and/or the path planning software 214 can be executed by a computing device, such as the computing device 400 described with respect to FIG. 4.

A communication path 216 may be established between the first agricultural machine 202 and the second agricultural machine 204 via which the first agricultural machine 202 may regularly (e.g., at a frequency of “X” Hertz, whereby “X” may be any predefined value) communicate with the second agricultural machine 204. Alternatively, or additionally, the first agricultural machine 202 may communicate with the second agricultural machine 204 in an infrequent (i.e., irregular) manner. For example, the first agricultural machine 202 may transmit its GPS position or its set path plan to the second agricultural machine 204 based upon completion of its initial traversal of the field or based on an operator (i.e., a user) manually initiating transmittal of such data to the second agricultural machine 204. The first agricultural machine 202 may also transmit its speed and/or direction to the second agricultural machine 204.

In an example, the first agricultural machine 202 may initially traverse the field so that a path plan of the first agricultural machine 202 may be set using the techniques described above. The path plan may of the first agricultural machine 202 may then be transmitted to the second agricultural machine 204, such as via the communication path 216, at which point a path plan of the second agricultural machine 204 may be set. When the second agricultural machine 204 initiates traversal of the field based on the path plan of the second agricultural machine 204, the first agricultural machine 202 may transmit its GPS position, speed, direction, or a combination thereof to the second agricultural machine 204 to ensure that the second agricultural machine 204 does not collide with the first agricultural machine 202. That is, the communication path 216 may be used to determine a relative position of the first agricultural machine 202 to the second agricultural machine 204.

The communication path 216 can be established using various technologies, including but not limited to Wireless Fidelity (Wi-Fi) such as a wireless local area network (WLAN), which allows machines to communicate within a certain range and can be effective for short-range communication and can support high data transfer rates; cellular networks (such as utilizing mobile networks (e.g., 4G, 5G)); Bluetooth, which is a short-range wireless technology standard that enables machines to exchange data over short distances; radio frequency, which uses specific radio frequencies for communication; satellite communication, which employs satellite links to transmit data; or Ultrawideband (UWB), which is a wireless communication protocol that uses a wide spectrum of frequencies for short-range, high-bandwidth communications.

As discussed above, GPS positions, speed, direction, or a combination thereof may be determined for the first agricultural machine 202 and/or the second agricultural machine 204 and transmitted therebetween. In an example, such parameters may be determined using real-time data from onboard sensors, such as sensors within the GPS units 208, 212, inertial measurement units (IMUs), cameras, and other positional tracking devices. For example, the GPS units 208 may include one or more sensors that are located on the first agricultural machine 202 and the implement 206, and the GPS unit 212 may include one or more sensors that are located on the second agricultural machine 204. Data obtained from such onboard sensors can be processed to determine the GPS position, speed, direction, or combination thereof of the first agricultural machine 202 and/or the second agricultural machine 204. Similarly, the data obtained from such onboard sensors can be processed to determine the GPS position, speed, direction, or a combination thereof of the implement 206 coupled to the first agricultural machine 202. As such, operation of the first agricultural machine 202 (including the implement 206) and the second agricultural machine 204 may be accurately tracked.

The GPS position, speed, direction, or a combination thereof of the first agricultural machine 202 during the initial traversal of the field may be used to set the path plan of the first agricultural machine 202. The path plan may also be set based on additional data. For example, the first agricultural machine 202 may be identified, based on an identifier (e.g., a VIN). Once identified, pre-stored data can be retrieved, such as from a configuration data. In an example, data for the first agricultural machine 202 and/or the second agricultural machine 204 may be retrieved from a remote configuration system 218 that includes or has access to configuration data, where each machine’s specific parameters are stored. The pre-stored data may be or may include machine parameters such as dimension, weight, max speed, or the like, which may then be utilized by the path planning software 210 to set the path plan of the first agricultural machine 202. Alternatively, or additionally, a user may manually input or adjust the parameters, such as the pre-stored data, associated with the first agricultural machine 202 through one or more user interfaces.

In an example, removable sensors may be temporarily attached at different defined locations of an agricultural machine or implement, allowing the path planning software 210 and/or the path planning software 214 to obtain data (e.g., GPS locations) to determine and set the path plan. These sensors can include accelerometers, gyroscopes, ultrasonic sensors, GPS sensors (e.g., GPS receivers), or other types of positional and motion detection devices. The data collected from these removable sensors can be used to accurately map the geometric and position characteristics of the machines or implement, which may then be stored for later retrieval. For example, a sensor attached to the top of a tractor can provide precise positional data that can be used to set the path plan of the first agricultural machine 202. Similarly, sensors placed at various points along a harvester can help determine its dimensions and alignment relative to the tractor. In an example, the path planning software may identify a list of sensors currently attached to the agricultural machine and guide the operator to associate each identified sensor with a specific component, location, or measurement on the machine or implement.

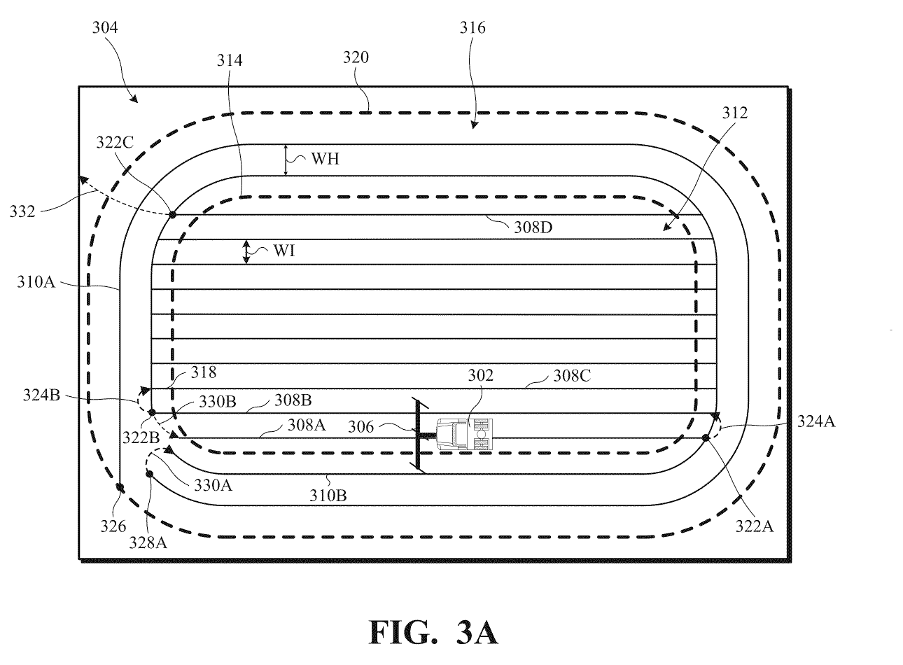

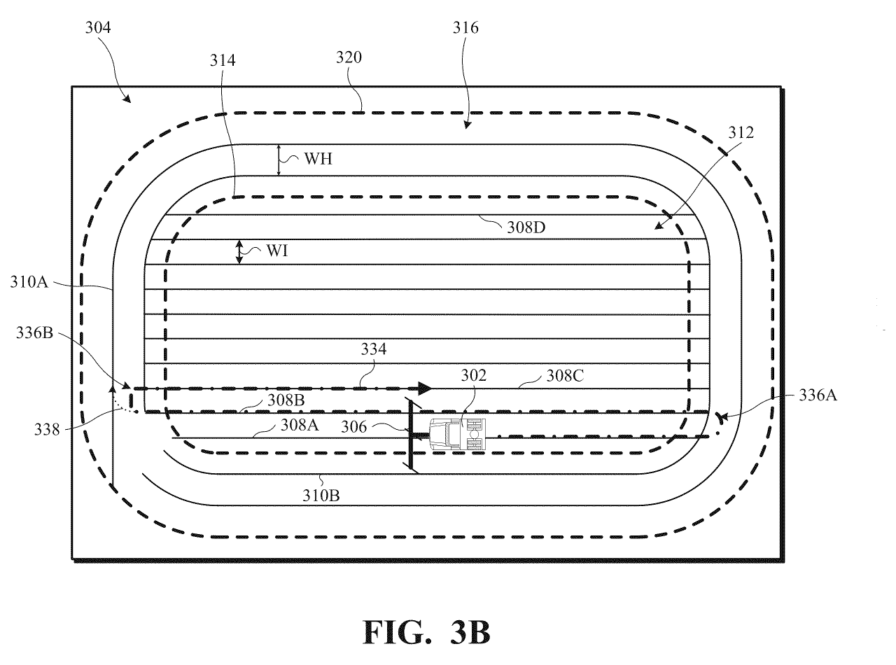

FIG. 3A illustrates identifying a path plan for an agricultural machine 302. The path plan may be based on an initial traversal of field 304 by the agricultural machine 302 or another agricultural machine that traverses the field 304 prior to the agricultural machine 302. As mentioned, a path plan includes a set of guidance lines that direct movement of the agricultural machine 302 across the field 304, ensuring precise and efficient execution of its tasks. These guidance lines are derived from the recorded positions of the agricultural machine which initially traversing the field 304 (e.g., the agricultural machine 302 or the other agricultural machine). By basing the path plan on the initial machine’s traversal, field operations are optimized, ensuring consistent traversal through the field 304 to ensure proper overlap and/or gaps.

Managing guidance lines throughout the crop year from strip till to harvest is a complex task. The difficulty of maintaining pre-plant fertilizer strips, avoiding crop rows while spraying, and accurately counting rows at harvest are well-known challenges in agriculture. Automatically creating guidance lines can optimize field operations across different phases of farming. Guidance lines can be generated using crop row maps created during a previous (e.g., initial) pass through the field, whether it is strip tilling or planting. For example, farmers need only place an implement receiver and/or an agricultural machine receiver on their implement and agricultural machine, respectively, during the first pass to map necessary data. Subsequently, path planning software, such as the path planning software 210 of FIG. 2, automatically generates guidance lines for subsequent passes, such as planting, spraying, or harvesting, regardless of equipment width.

In an example, the path plan may be generated by a remote system, such as the remote configuration system 218 of FIG. 2, and received by the path planning software. In such a case, the path plan is said to be generated offboard (i.e., not at the agricultural machine 302 itself). This automation ensures that each pass begins quickly and confidently, enhancing the efficiency of farming operations by maintaining established guidance lines and reducing the risk of partial width passes. By generating guidance lines, yield potential can be protected by accurately planning rows to optimize nutrient investment and minimizing soil disturbance, while keeping agricultural machine tires between rows to prevent crop damage throughout the growing season.

The field 304 may be first (i.e., initially) traversed by the agricultural machine 302 to which an implement 306 that can process crop rows is attached. Data (i.e., traversal data) associated with the traversal of the field 304 by the agricultural machine 302 may be recorded. For example, during the initial traversal of the field 304, the agricultural machine 302 may take one or more in-field passes, such as the in-field passes 308A-308C, and one or more headland passes, such as the headland passes 310A, 310B. As discussed above, the in-field passes 308A-308C may be a series of generally parallel passes located substantially or entirely within an in-field 312 of the field 304 defined by an in-field perimeter 314. The in-field 312 may generally be the region of the field 304 that contains the crop.

As shown in FIG. 3A, the in-field passes 308A-308C may be substantially located within the in-field 312 yet may extend beyond the in-field perimeter 314 into a headland 316 of the field 304. For example, a portion 318 of the in-field pass 308C may extend outside of the in-field 312 (e.g., outside of the in-field perimeter 314) into the headland 316. The headland 316 may extend between the in-field 312 and an outer perimeter 320 of the field 304 to form a border at least partially around the in-field 312. The headland 316 may be an unworked area or a region of the field 304 that does not contain crop. As such, the in-field passes 308A-308C may extend beyond the in-field perimeter 314 so that the agricultural machine 302 may execute turns at the end of each of the in-field passes 308A-308C (e.g., to transition between consecutive in-field passes) within the headland 316 to avoid damage to the crops located within the in-field 312.

For example, as shown in FIG. 3A, the agricultural machine 302 may begin traversal along the in-field pass 308A. When the agricultural machine 302 reaches an end 322A of the in-field pass 308A, the agricultural machine 302 may execute a turn 324A to transition from the in-field pass 308A to the in-field pass 308B. The agricultural machine 302 may continue along the in-field pass 308B until it reaches an end 322B of the in-field pass 308B, at which point the agricultural machine 302 may execute another turn 324B to transition from the in-field pass 308B to the in-field pass 308C. The agricultural machine 302 may continue in a similar manner to traverse a remainder of the in-field 312 (i.e., along the remaining in-field passes, transitioning between consecutive in-field passes by executing turns similar to the turns 324A, 324B).

The headland passes 310A, 310B may be located substantially or entirely within the headland 316. Each headland pass may allow the agricultural machine 302 to navigate a perimeter of the in-field (e.g., navigate outside of the in-field perimeter 314). For example, the agricultural machine 302 may be configured to travel along the headland passes 310A, 310B to define the outer perimeter 320 of the field 304 and/or to define the in-field perimeter 314. Moreover, one or more of the in-field passes 308A-308C may connect to one or more of the headland passes 310A, 310B, such as by one or more turns executed by the agricultural machine 302.

To further illustrate, as shown in FIG. 3A, the agricultural machine 302 may enter the headland 316 (i.e., enter the headland 316 from an area outside of the outer perimeter 320) at an entry point 326. Upon entering the headland 316, the agricultural machine 302 may traverse the headland pass 310A until it reaches an end 328 of the headland pass 310A, at which point the agricultural machine 302 may execute a turn 330A to transition from the headland pass 310A to the headland pass 310B. The agricultural machine 302 may continue along the headland pass 310B until it reaches an end of the headland pass 310B, which in this example may be the same the end 322B of the in-field pass 308B. Once the agricultural machine 302 reaches the end of the headland pass 310B, the agricultural machine 302 may execute a turn 330B to transition from the headland pass 310B to the in-field pass 308A. The agricultural machine 302 may then continue along the in-field passes, including the in-field passes 308A-308C, as described above, to traverse through the in-field 312.

The agricultural machine 302 may traverse the in-field 312 until it reaches an end point 322C of a final in-field pass 308D. The agricultural machine 302 may then continue from the final in-field pass 308D to the headland pass 310B, at which point the agricultural machine 302 may traverse along the headland pass 310B, transition to the headland pass 310A (e.g., via a turn similar to the turn 330A, but in an opposing direction), and traverse along the headland pass 310A until it reaches the entry point 326 to exit the field 304. Alternatively, when the agricultural machine 302 reaches the end point 322C of the final in-field pass 308D, the agricultural machine 302 may more directly exit the field 304, such as along an exit path 332.

Data (e.g., traversal data) associated with the traversal of the field 304 by the agricultural machine 302 may be recorded. In particular, data may be recorded when the agricultural machine 302 traverses the in-field passes 308A-308D and the headland passes 310A, 310B. Locations and lengths of the in-field passes 308A-308D and the headland passes 310 may be determined based on the traversal data. As discussed above, the in-field passes 308A-308D and the headland passes 310A, 310B may correspond to discrete portions of the initial travel path of the agricultural machine 302 during an initial traversal of the field 304. The traversal data can be transmitted to a configuration system, such as the remote configuration system 218 of FIG. 2.

Recording of the traversal data may be manually initiated (e.g., triggered or started). For example, an operator may manually operate the agricultural machine 302 during the initial traversal of the field 304. In such a case, the operator may manually initiate, such as via a user interface of the agricultural machine 302, recording of traversal data. For example, the operator may manually initiate recording of traversal data when the agricultural machine 302 is following along the in-field passes 308A-308D and/or the headland passes 310A, 310B. However, the operator may manually pause or stop recording traversal data when the agricultural machine 302 is turning between the in-field passes 308A-308C and/or the headland passes 310A, 310 such that the traversal data may clearly identify the discrete passes. For example, the operator may manually pause or stop recording traversal data when the agricultural machine 302 is executing turns within the headland, such as the turns 324A, 324B between the in-field passes 308A-308C, the turn 330A between the headland passes 310A, 310B, or the turn 330B between the headland pass 310B and the in-field pass 308A.

Recording of the traversal data may also be automatically initiated. For example, recording may be initiated and/or stopped based upon operation of the implement 306. In an example, the implement 306 may be a harvester that may be raised and lowered relative to the ground to harvest the crops. When the implement 306 is lowered to harvest the crops, traversal data may automatically be recorded. Conversely, when the implement 306 is raised (e.g., no longer in contact with the ground to harvest the crops, such as when executing turns between passes as described above), recording of the traversal data may be automatically paused or stopped. Thus, portions of the travel path of the agricultural machine 302 in which the implement 306 is lowered may correspond to the discrete in-field passes 308A-308D whereas the portions of the path of travel in which the implement 306 is raised may correspond to the turns (e.g., the turns 324A, 324B) or gaps between such in-field passes 308A-308D. As such, the in-field passes 308A-308D may be determined based upon determining when the implement 306 is operating.

After initial traversal of the field 304 by the agricultural machine 302, the traversal data may be used to set a path plan for subsequent operations (e.g., later during the season). For example, another agricultural machine (i.e., a second agricultural machine) may subsequently traverse the field 304. As such, the path plan may automatically generate guidance lines that correspond to the in-field passes 308A-308D and/or the headland passes 310A, 310B for the second agricultural machine. That is, the path plan may initially generate a map according to the in-field passes 308A-308D and/or the headland passes 310A, 310B to generate the path plan. The path plan can be generated by the configuration system and transmitted to the second agricultural machine (e.g., to a path planning software therein). In another example, the path plan can be generated by the path planning software of the second machine based on the traversal data received from the configuration system.

It should be noted the path plan generated may be the same as the initial travel path of the agricultural machine 302 or may deviate from the initial travel path of the agricultural machine 302. For example, a width (WI) between the in-field passes 308A-308D and/or a width (WH) between the headland passes 310A, 310B may differ between the path plan and the initial travel path of the agricultural machine 302. Consider the implement 306 of the agricultural machine 302. The implement 306 may have a certain width, which may correlate to the number of rows of crops that the implement 306 may address (e.g., harvest, spray, plant, etc.) The number of in-field passes and/or the number of headland passes may be dictated by the width of the implement 306. That is, the agricultural machine 302 may only need to traverse as many of the in-field passes as needed to accurately and effectively cover the in-field 312. As such, when traversal data is recorded for the agricultural machine 302 towing the implement 306, the traversal data may represent the travel path needed when towing the implement 306.

Conversely, the second agricultural machine may have an implement that is narrower or wider than the implement 306. As a result, the path plan generated for the second agricultural machine may require more or less of the in-field passes to effectively cover the in-field 312. For example, if the implement of the second agricultural machine is wider than the implement 306, the second agricultural machine may only need to traverse the in-field pass 308A and the in-field pass 308C (i.e., skip the in-field pass 308B and transition directly from the in-field pass 308A to the in-field pass 308C) to effectively cover the in-field 312 between the in-field pass 308A and the in-field pass 308C. As such, the path planning software or the configuration system in communication with the second agricultural machine may deviate from the initial travel path of the agricultural machine 302 to eliminate unnecessary passes and thereby minimize overlap and/or damage to the crops.

The path plan generated may also include turns (i.e., connections) between the passes (e.g., between the in-field passes 308A-308D, between the headland passes 310A, 310B, between the headland pass 310B and the in-field pass 308A, etc.). For example, FIG. 3B illustrates generated path 334 based upon an initial traversal of the field 304, such as the initial traversal of the field 303 by the agricultural machine 302 described above and illustrated in FIG. 3A. The generated path 334 may include a turn path generated between two of the in-field passes, such as the turn path 336A between the in-field pass 308A and the in-field pass 308B and the turn path 336B between the in-field pass 308B and the in-field pass 308B, as part of the path plan for the agricultural machine 302. As shown in FIG. 3B, the turn paths 336A, 336B may be located substantially or entirely within the headland 316 of the field 304 and may connect the in-field passes 308A-308C such that the agricultural machine 302, when traversing the generated path 334, may traverse along the in-field pass 308A, execute a turn according to the turn path 336A, traverse along the in-field pass 308B, execute an additional turn according to the turn path 336B, and thereafter continue along the in-field pass 308C. It should be noted that the generated path 334 shown in FIG. 3B is intended to illustrate only a segment of an example of a generated path. That is, the generated path 334 may extend substantially throughout the in-field 312 and/or the headland 316 to provide guidance to the agricultural machine 302 to effectively cover the in-field 312.

As described above, the path plan may be based on an initial traversal of the field 304 by the agricultural machine 302 or another agricultural machine. During such initial traversal, traversal data (e.g., GPS location, speed, direction, etc.) may be recorded. Using the techniques described above, the traversal data may be used to determine the in-field passes 308A-308D and the headland passes 310A, 310B. For example, the path planning software of the agricultural machine 302 may obtain the traversal data from the initial traversal of the field 304 and identify the in-field passes 308A-308D and the headland passes 310A, 310B. The path planning software or the remote configuration system may thus derive (e.g., generate) the map based upon at least the in-field passes 308A-308D and the headland passes 310A, 310B. That is, the path planning software may generate the map from the traversal data that may identify and locate the in-field passes 308A-308D and the headland passes 310A, 310B within the field 304.

The map may also include one or more other parameters in addition to the traversal data. In an example, the operator may manually input (e.g., via a user interface) the in-field perimeter 314 and/or the outer perimeter 320 of the field 304 so that the path planning software may be able to identify the headland 316 of the field 304. Alternatively, the path planning software may be able to identify the outer perimeter 320 and/or the in-field perimeter 314 based upon traversal of the headland passes 310A, 310B by the agricultural machine 302, and thus may be able to identify the headland 316 of the field 304. In another example, the path planning software may obtain the in-field perimeter 314 and/or the outer perimeter 320 from an external location, such as from the remote configuration system 218 of FIG. 2. As such, the path planning software may more accurately locate the in-field passes 308A-308D and the headland passes 310A, 310B relative to the in-field 312 and the headland 316.

Conventionally, path planning may often be unable to distinguish between the in-field passes 308A-308D and the headland passes 310A, 310B. As a result, the path plan may often include incorrect turns. For example, as shown in FIG. 3B, the path plan may generate an incorrect turn 338 that connects the in-field pass 308B to the headland pass 310A instead of correctly connecting the in-field pass 308B to the in-field pass 308C (e.g., via the turn path 336B). Such incorrect turns may be generated due to a lack of distinguishing between the in-field passes 308A-308D and the headland passes 310A, 310B. As a result, conventional path planning may inadvertently generate a path plan that is inconsistent, not optimized, or otherwise fails to properly cover an entirety of the in-field 312 for a particular task of the agricultural machine 302 (e.g., harvesting, cultivating, planting, etc.) For example, generating turns similar to the incorrect turn 338 may result in one or more of the in-field passes 308A-308D being inadvertently skipped. Similarly, generating turns similar to the incorrect turn 338 may result in additional traversal of the field 304 (e.g., backtracking, unnecessary turns, etc.), which may put more stress on the crops located within the in-field 312.

The path planning described herein may alleviate the above issues. In particular, by identifying the headland 316 and the in-field 312, initial traversal of the field 304 may be monitored relative to both the headland 316 and the in-field 312. As described above, the GPS position of the agricultural machine 302 may be tracked during the initial traversal of the field 304 to obtain a set of GPS positions along the initial travel path of the agricultural machine 302. The path planning software of the agricultural machine 302, or the remote configuration system in communication therewith, may determine whether the GPS positions of the agricultural machine 302 are located within the headland 316 or the in-field 312 to identify the in-field passes 308A-308D and the headland passes 310A, 310B.

As discussed above, the passes of the agricultural machine 302 may be determined based upon recording of the traversal data. The passes may correspond to discrete portions of the initial travel path (e.g., discrete portions when the implement 306 is active) of the agricultural machine 302. Thus, the path planning software of the agricultural machine 302 may generate a map of all of the identified passes from the initial path of travel. Additionally, due to the in-field perimeter 314 and the outer perimeter 320 being defined within the path planning software (e.g., via user input or obtaining data from the configuration system), the path planning software may be able to evaluate the passes relative to the in-field 312 and the headland 316.

For example, as described further below, any particular pass may be evaluated to determine how much (i.e., what portion) of the pass is located within the in-field 312 versus the headland 316 and compare that amount to a predefined threshold to identify the particular passes as an in-field pass or a headland pass. In an example, if the pass is located substantially or entirely within the in-field 312 (e.g., exceeds a predefined threshold for an amount of the pass located within the in-field 312), then the pass may be identified as one of the in-field passes 308A-308D. Conversely, if the pass does not exceed the predefined threshold – that is, the portion of the pass located within the in-field 312 does not exceed the predefined threshold – then the pass may be identified as one of the headland passes 310A, 310B.

By identifying the in-field passes 308A-308D and the headland passes 310A, 310B, the path planning software may correctly establish turn paths, such as the turn paths 336A, 33B, to connect the in-field passes 308A-308D to one another to ensure that the agricultural machine 302 effectively follows the generated path 334 through the in-field 312 without unnecessary backtracking, overlap, or connections between the in-field passes 308A-308D and the headland passes 310A, 310B. Thus, only necessary connections between the in-field passes 308A-308D and the headland passes 310A, 310B can be identified, such as those needed to facilitate the agricultural machine 302 entering and exiting the in-field 312.

By way of example, the path planning software or the remote configuration system may calculate turn paths between identified passes (e.g., between the in-field passes 308A-308D or between the headland passes 310A, 310B) based upon: parameters of the field 304, such as one or more of a location of the outer perimeter 320 of the field 304, a location of the in-field perimeter 314, a location of the headland 316, and a location of the in-field 312; parameters of the agricultural machine 302, such as one or more of a turn radius, a width, a weight, and a max speed of the agricultural machine 302; parameters of the implement 306, such as a width and/or a weight of the implement 306; operational parameters, such as one or more of a desired overlap between passes (e.g., a desired overlap based upon a width of the implement 306). a desired speed, a width (e.g., the width (WH) or the width (WI) between passes, a location of the passes; other parameters; or a combination thereof.

For example, consider the turn path 336B generated between the in-field pass 308B and the in-field pass 308C. The path planning software may identify that the in-field pass 308C is the next nearest in-field pass (assuming the generated path 334 starts from the in-field pass 308A and continues to the in-field pass 308B via the turn path 336A). The path planning software may also identify that the headland 316 is located adjacent to the in-field pass 308B. However, the path planning software may recognize that in-field passes remain (e.g., the in-field passes 308C) that are not yet part of the generated path 334. As a result, the path planning software may determine that it would be ineffective to generate a turn path from the in-field pass 308B to the headland pass 310A (e.g., similar to the incorrect turn 338). As such, the path planning software may generate the turn path 336B to connect the in-field pass 308B to the in-field pass 308C. The turn path 336B may be generated based upon the width (WI) between the in-field pass 308B and the in-field pass 308C, parameters of the agricultural machine 302, parameters of the implement 306, or a combination thereof.

FIG. 4 is a diagram of an example of a computing device 400. The computing device 400 is shown as including a processor 402, a memory 404, a user interface 406, and a communication interface 408. The computing device 400 may be implemented by an agricultural machine, such as the agricultural machine 100 of FIGS. 1A and 1B, the first agricultural machine 202 and the second agricultural machine 204 of FIG. 2, or the agricultural machine 302 of FIGS. 3A and 3B. The computing device 400 may facilitate communication between the agricultural machine and other computing devices, which may be remote from the machine. The computing device 400 can execute instructions such as those of a path planning software.

The processor 402 may be a microprocessor, and may include a single processor or multiple processors. A processor may have a single processing core or multiple processing cores. The processor 402 may be or include other types of devices, or multiple devices, now existing or hereafter developed, configured for manipulating or processing information. The computing device 400 may include multiple processors interconnected in one or more manners, including but not limited to, hardwired, or networked (e.g., wirelessly networked). By way of example, the operations of the processor 402 may be distributed across multiple devices or units that may be coupled directly or via a local area or other suitable network. The processor 402 may also include a cache or cache memory for local storage of operating data or instructions associated with the evaluation.

The memory 404 may include one or more memory components, which may each be volatile memory or non-volatile memory. For example, the volatile memory of the memory 404 may be random access memory (RAM) (e.g., a DRAM module, such as DDR SDRAM) or another form of volatile memory. In another example, the non-volatile memory of the memory 404 may be a disk drive, a solid-state drive, flash memory, phase-change memory, or another form of non-volatile memory configured for persistent electronic information storage. The memory 404 may also include other types of devices, now existing or hereafter developed, configured for storing data or instructions for processing by the processor 402.

The memory 404 can include data for immediate access by the computing device 400. For example, the memory 404 may include executable instructions, application data, an operating system, or a combination thereof accessible by the processor 402. The executable instructions, the application data, the operating system, or a combination thereof may be loaded or copied, in whole or in part, from non-volatile memory to volatile memory to be executed by the computing device 400. For example, the executable instructions and application data may include instructions and data for, as described herein, path planning; pass mapping based upon an initial path of travel of the agricultural machine; pass identification (e.g., identifying in-field passes and headland passes); and machine control (e.g., autonomous control).

The memory 404 may include executable instructions or application data associated with a communication interface 408. The communication interface 408 may be or may include a transmitter and/or a receiver. The communication interface 408 may facilitate communication between, for example, agricultural machines (i.e., a first agricultural machine and a second agricultural machine. For example, the communication interface 408 may enable data exchange over a communication path, thereby allowing for real-time synchronization and data updates between the agricultural machines.

The user interface 406 may include one or more input interfaces and/or output interfaces. An input interface may be, for example, a positional input device, such as a mouse, touchpad, touchscreen, or the like; a keyboard; or another suitable human or machine interface device. An output interface may be, for example, a display, such as a liquid crystal display, a cathode-ray tube, a light emitting diode display, or other suitable display. As such, an operator may interact with a path planning software, a remote configuration system, select or configure agricultural machines and implements, view real-time positional data, and monitor the status of machine synchronization through the user interface 406. Additionally, the user interface 406 may provide visual indicators and alerts to assist the operator in maintaining optimal machine operation and synchronization.

The computing device 400 may include additional components. For example, the computing device 400 may include power management units, various sensors for monitoring environmental conditions and machine status, and interfaces for connecting to external storage devices or other peripherals. These components ensure that the computing device 400 operates reliably in various agricultural environments and can handle the processing and communication demands of the machine sync system.

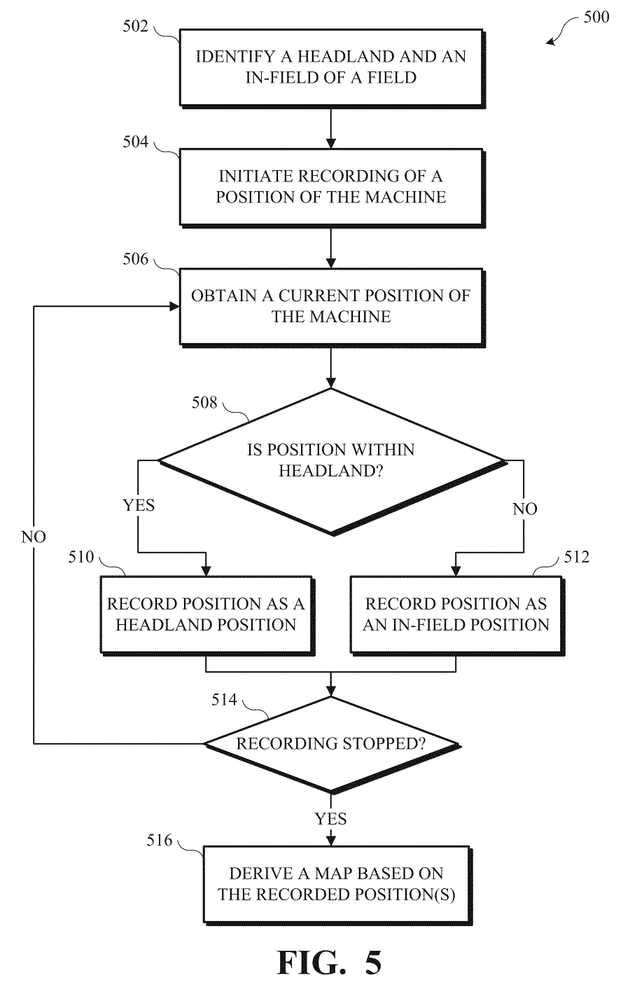

To further describe some implementations in greater detail, reference is next made FIG. 5, which is a flowchart of a first example of a technique 500 for deriving a map based on a position of an agricultural machine (e.g., the agricultural machine 302 of FIGS. 3A and 3B). The technique 500 may identify a headland and an in-field of a field and compare recorded positions of the agricultural machine with the headland and the in-field to determine whether the recorded positions are located in the headland or the in-field. The map may then be derived based on the recorded positions of the agricultural machine. The map may also include a representation of the path traveled by the agricultural machine.

The technique 500 can be executed using computing devices, such as the systems, hardware, and software described with respect to FIGS. 1A-4. The technique 500 can be performed, for example, by executing by a machine-readable program or other computer-executable instructions, such as routines, instructions, programs, or other code. The steps, or operations, of the technique 500, or another technique, method, process, or algorithm described in connection with the implementations disclosed herein, can be implemented directly in hardware, firmware, software executed by hardware, circuitry, or a combination thereof. The technique 500 can be executed by a path planning software, such as the path planning software 210 or the path planning software 214 of FIG. 2. The technique 500 can additionally, or alternatively, be executed by a remote configuration system, such as the remote configuration system 218 of FIG. 2.

For simplicity of explanation, the technique 500 is depicted and described herein as a respective series of steps or operations. However, the steps or operations of the technique 500 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 502, a headland of a field is identified. The headland of the field may be identified based upon user input or may be obtained via communication with an external device (e.g., the remote configuration system), such as using the techniques described above to identify the headland 316 shown in FIGS. 3A and 3B. For example, the user may manually input (e.g., via the user interface 406 of FIG. 4) an in-field perimeter and an outer perimeter of the field so that the technique 500 may identify a region between the in-field perimeter and the outer perimeter as the headland. Using the field 304 shown in FIGS. 3A and 3B as an example, the user may manually input the in-field perimeter 314 and the outer perimeter 320 such that the technique 500 may determine that the region located therebetween is the headland 316.

By manually inputting the in-field perimeter and the outer perimeter of the field, the in-field may also be identified by the technique 500. For example, at 502, the in-field may be determined to be a region contained with the manually input in-field perimeter. As a result, the technique 500 may identify the regions of the field that correspond to the headland and the in-field. In some implementations, only the headland or the in-field need to be identified.

The in-field perimeter and/or the outer perimeter may also be obtained by the technique 500 (e.g., not manually input by the operator), such as by retrieving such data from a configuration system. The data may include the in-field perimeter and/or the outer perimeter of the field. As such, the configuration system may store one or more predefined parameters or other data, which may be received by the technique 500.

Once the headland is identified at 502, the recording of a position of the agricultural machine may be initiated at 504. As discussed above, the position of the agricultural machine may be tracked using one or more GPS units (e.g., GPS receivers located on the agricultural machine). Using the agricultural machine 100 of FIGS. 1A and 1B as an example, the agricultural machine 100 may include a guidance system 106, which may be or may include a GPS unit. The first sensor 110 and/or the second sensor 112 may form or be part of the GPS unit. For example, the first sensor 110 may be a GPS receiver disposed on the body 102 of the agricultural machine 100 that is configured to obtain a GPS position of the agricultural machine 100 based upon communication with one or more GPS satellites. In a similar manner, an implement coupled to the agricultural machine (e.g., in the case of the agricultural machine 100, the implement 122) may also be tracked to obtain a GPS position of the implement.

Initiating recording at 504 may be initiated manually or automatically. For example, as discussed above, recording may be initiated manually by an operator, such as through a user interface of the agricultural machine. Alternatively, or additionally, recording may be automatically initiated based upon activity of the implement connected to the agricultural machine. In an example, the agricultural machine may be a tractor pulling a harvester (i.e., the implement). The harvester may be configured to raise or lower such that the operator of the tractor may lower the harvester to harvest the crops and thereafter raise the harvester so that the harvester no longer contacts the crops. In such a case, recording of a position of the agricultural machine may be initiated when the harvester is lowered, and recording may be paused or stopped when the harvester is raised.

Once recording is initiated at 504, a current position of the agricultural machine may be obtained at 506. In an example, recording positions of the agricultural machine may be continuously performed to track a travel path of the agricultural machine. For example, the GPS unit of the agricultural machine may receive data (e.g., data associated with the current position of the agricultural machine) from the GPS satellites every t seconds, where t may be any predefined time interval. As such, the technique 500 may obtain a data set corresponding to consecutive positions of the agricultural machine along the travel path. That is, the data set may include any number of data points, where each of the data points may correspond to a distinct position of the agricultural machine along the travel path at a given time. Thus, the technique 500 may accurately map out the travel path of the agricultural machine by connecting the data points in sequential order.

For each of the positions obtained at 506, an evaluation may be completed at 508 to determine whether the position is located within the headland of the field. For example, each of the GPS positions may be mapped on a digital representation of the field. For example, the digital representation of the field may be similar to the representation of the field 304 shown in FIG. 3A. The digital representation of the field may include an outer perimeter of the field, an in-field perimeter, a region identified as the headland (e.g., based on identification at 502), a region identified as the in-field (e.g., based on identification at 502), or a combination thereof. As such, the GPS positions of the agricultural machine may be mapped relative to the aforementioned perimeters and/or regions. Because the headland is identified at 502, the technique 500 may evaluate whether each of the positions obtained at 506 are located within the identified headland.

If the position is located within the headland, the position may be recorded as a headland position at 510. Recording of the position as a headland position may be considered any means of storing the GPS position obtained at 506 within a computing device of the agricultural machine and/or the remote configuration system with an identifier that correlates the obtained position as a headland position. For example, the GPS position obtained at 506 may be stored in a memory of a computing device configured to execute the path planning software, such as the memory 404 of FIG. 4. The GPS position may be stored with any type of identifier used for categorizing data points, such as descriptive identifiers (e.g., a name, code, tag, etc.), numeric identifiers, alphanumeric identifiers (e.g., strings, codes, etc.), or other means.

If the position is not located within the headland, the position may be recorded as an in-field position 512. Recording of the position as an in-field position may done in a similar manner as recording a position as a headland position, as described above. For example, the GPS position obtained at 506 may be stored (e.g., within the computing device of the agricultural machine and/or the remote configuration system)with an identifier that correlates the obtained position as an in-field position. The identifier can be any type of identifier for categorizing data points, such as those described above.

At 514, it is determined whether recording of the positions of the agricultural machine has stopped. The recording may be stopped manually (e.g., via user input) or automatically (e.g., based on implement activity) as described above. If recording is not stopped, then the technique 500 proceeds back to 506. Any number of iterations of steps 506-514 may be completed to determine any number of positions of the agricultural machine. For example, each iteration of 506-514 (e.g., between initiating recording and stopping recording) may correspond to a particular pass (e.g., an in-field pass or a headland pass) of the agricultural machine along the travel path such that the obtained positions of the agricultural machine may correspond to positions along the particular pass. Thus, any number passes may be obtained, where each of the passes may be considered a discrete segment of the overall travel path of the agricultural machine.

Once recording is determined to be stopped at 514, the technique 500 derives a map. The map may be based on the recorded positions (e.g., GPS positions) of the agricultural machine. That is, the map may be derived based upon the recorded headland positions and the recorded in-field positions. Moreover, as described above, due to operations 506-514 being iterative in nature, passes taken by the agricultural machine along the travel path may be identified. Thus, when the map is derived at 516, the passes taken by the agricultural machine within the overall travel path may be easily identified. That is, due to recording being stopped at 514 between each pass, the map may illustrate those gaps to define the passes. For example, the map may be generated and may be similar to the representation of the field 304 shown in FIG. 3A, where the outer perimeter 320 of the field, the in-field perimeter 314, the in-field passes 308A-308D, and the headland passes 310A, 310B are visually represented based upon the obtained positions of the agricultural machine.

In an example, the map derived at 516 may illustrate each pass as a curve (e.g., line) connecting any number of recorded positions (e.g., headland positions and/or in-field positions). The recorded positions that are connected may all be from the same iteration of operations 504-514. That is, the technique 500 may group or categorize each recording (e.g., each iteration of operations 504-514) and the obtained positions therein so that, when the map is derived at 516, the group of obtained positions may be connected to form a curve (e.g., line). However, groups of obtained positions (e.g., a first group of obtained positions from a first recording and a second group of obtained positions from a second recording) may be maintained separately so that, when the map is derived at 516, positions from one group are not connected to positions from another group. As a result, the map may illustrate discrete line segments, which correspond to the passes, and gaps (i.e., no lines) located between the passes.

To further illustrate, reference is once again made to FIGS. 3A and 3B. In an example, a first recording (e.g., corresponding to a first iteration of operations 506-514) may correspond to the in-field pass 308A, whereby the in-field pass 308A may be considered a first discrete line segment of the overall travel path taken by the agricultural machine. Similarly, a second recording (e.g., corresponding to a second iteration of operations 506-514) may correspond to the in-field pass 308B and a third recording (e.g., corresponding to a third iteration of operations 506-514) may correspond to the headland pass 310A, whereby the in-field pass 308B may be considered a second discrete line segment and the headland pass 310A may be considered a third discrete line segment.

When the map is derived at 516, a first line (i.e., the first discrete line segment) may be created to illustrate the in-field pass 308A, a second line (i.e., the second discrete line segment) may be created to illustrate the in-field pass 308B, and a third line (i.e., the third discrete line segment) may be created to illustrate the headland pass 310A. However, the first line, the second line, and the third line may remain disconnected from one another to clearly identify the separate passes (e.g., the in-field passes 308A, 308B and the headland pass 310A). As such, the map may be generated to accurately provide a representation of the travel path of the agricultural machine, including the discrete passes taken therein.

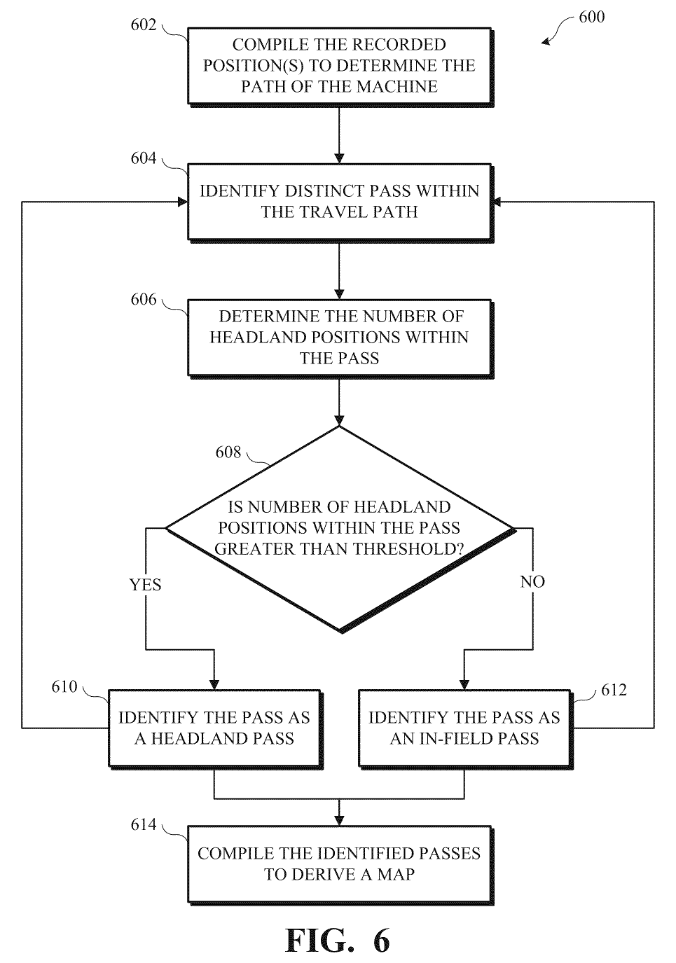

FIG. 6 is a flowchart of an example of a technique 600 for deriving a map based on passes of an agricultural machine (e.g., the agricultural machine 302 of FIGS. 3A and 3B) along a travel path of the agricultural machine. The technique 600 may include identifying distinct passes taken by the agricultural machine during an initial traversal of a field and thereafter identifying each pass as an in-field pass or a headland pass. The identified in-field passes and headland passes may then be compiled to derive the map.

The technique 600 can be executed using computing devices, such as the systems, hardware, and software described with respect to FIGS. 1A-4. The technique 600 can be performed, for example, by executing by a machine-readable program or other computer-executable instructions, such as routines, instructions, programs, or other code. The steps, or operations, of the technique 600, or another technique, method, process, or algorithm described in connection with the implementations disclosed herein, can be implemented directly in hardware, firmware, software executed by hardware, circuitry, or a combination thereof. The technique 600 can be executed by a path planning software, such as the path planning software 210 or the path planning software 214 of FIG. 2. The technique 600 can additionally, or alternatively, be executed by a remote configuration system, such as the remote configuration system 218 of FIG. 2.

For simplicity of explanation, the technique 600 is depicted and described herein as a respective series of steps or operations. However, the steps or operations of the technique 600 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 602, recorded positions of the agricultural machine may be compiled to determine the travel path of the agricultural machine. For example, the positions may be recorded according to all or a portion of the technique 500 of FIG. 5. That is, positions of the agricultural machine along the travel path may be recorded and evaluated to determine whether each of the positions is located within the headland of the field (e.g., at operation 508 of the technique 500). Based upon such an evaluation, the positions may be recorded as a headland position (i.e., a position located within the headland) or an in-field position (i.e., a position located within the in-field), and the positions may then be mapped in a digital representation of the field to thereby compile the recorded positions.

In some implementations, if the position is determined to not be located in the headland, the position may be automatically recorded as an in-field position. Such an implementation may be based on the assumption that all recorded positions are located within the field (i.e., within an outer perimeter of the field and located either in the headland or the in-field). In an example, recording may only be initiated and/or commence when the agricultural machine is located within the headland or the in-field. As such, the technique 600 may not need to ascertain whether any of the obtained positions of the agricultural machine are located outside of the outer perimeter (i.e., outside of the field).

However, in some implementations, such as when the agricultural machine may travel outside of the outer perimeter (i.e., outside of the field), the evaluation may further include an additional evaluation to determine whether the obtained position is located within the in-field. Thus, the overall evaluation may include determining whether the position is located in the headland and whether the position is located in the in-field. As such, positions that are not located within the headland or the in-field may be categorized as outliers, which may if desired be excluded when deriving the map.

At 604, the technique 600 may identify a distinct pass within the travel path of the agricultural machine. As discussed above with respect to the technique 500 of FIG. 5, a distinct pass may correspond to a discrete portion of the travel path of the agricultural machine. For example, the discrete portion may correspond to a particular recording of positions of the agricultural machine, where a particular recording may be identified based upon activating and stopping or pausing the recording. As discussed above, recording may be manually initiated and stopped based upon user input or may be automatically initiated and stopped based on implement activity. In either case, the technique 600 may identify each recording as a separate, discrete portion of the travel path of the agricultural machine, where each discrete portion may correspond to a particular pass (i.e., a headland pass or an in-field pass).

Once the distinct passes are identified at 604, a number of headland positions within the identified pass may be determined at 606. As discussed above, each pass may be based on a data set, where the data set may comprise data points that correspond to positions (e.g., GPS positions) of the agricultural machine along the travel path. Each data points may be identified as a headland position or an in-field position using the techniques described above. As such, the data set for the identified pass may be evaluated to determine the number of recorded headland positions within the data set.

For illustrative purposes, consider an in-field pass, which may be similar to the in-field passes 308A-308D of FIGS. 3A and 3B. The in-field pass may correspond to a particular data set that comprises consecutively obtained positions of the agricultural machine along the travel path (i.e., data points of the data set). The technique 600 may identify the in-field pass by connecting the consecutively obtained data points to define a line. Additionally, since each of the data points obtained is recorded as an in-field position or a headland position, the technique 600 may further determine what number of the data points within the data set (i.e., for the identified pass) are headland positions. Consider an in-field pass that corresponds to a data set that comprises ten obtained positions of the agricultural machine. In such a case, the technique 600 may determine how many of the ten positions are recorded as headland positions. In the above example, the in-field pass may include, for example, two positions that are recorded as headland positions due to the agricultural machine overrunning the in-field beyond the in-field perimeter to facilitate turning of the agricultural machine within the headland.

Once the number of headland positions is determined at 606, the number of headland positions may be evaluated at 608. In an example, the technique 600 may evaluate whether the number of headland positions for the identified pass is greater than a predefined threshold. The predefined threshold may be any desired threshold. For example, the predefined threshold may correspond to a percentage. That is, the technique 600 may evaluate whether the number of headland positions makes up a percentage of the total recorded positions that exceeds the threshold percentage.

To further illustrate, consider the above example of an in-field pass that comprises a total of ten recorded positions, where two of the positions are headland positions. The technique 600 may thus determine that the headland positions make up 20% of the total number of recorded positions of the agricultural machine. As such, technique 600 may then evaluate, at 608, whether 20% is greater than the predefined threshold percentage.

If the number of headland positions within the identified pass is determined to be greater than the threshold, the pass may be identified as a headland pass at 610. Conversely, if the number of headland positions within the identified pass is less than the threshold (, the pass may be identified as an in-field pass at 612. In practice, when the majority or vast majority (e.g., greater than 85%, greater than 90%, greater than 95%) of recorded positions are located within the in-field, the pass may be identified as an in-field pass. Similarly, when the majority or vast majority (e.g., greater than 85%, greater than 90%, greater than 95%) of recorded positions are located within the headland, the pass may be identified as headland pass.

As such, the technique 600 may accurately determine and identify whether a pass is a headland pass or an in-field pass even when the pass is not entirely located within the headland or entirely located within the in-field. That is, the technique 600 may accurately determine that a pass is an in-field pass or a headland pass even when a portion of the positions recorded for the pass are located within the headland or the in-field, respectively.

Once the pass has been identified as headland passes or in-field passes, the technique 600 may repeat operations 604-612 to further identify any additional passes. That is, operations 604-612 may be iterative in nature to identify any number of passes taken by the agricultural machine. Once the passes have been identified, the map may be derived at 614. The map may be derived based on the identified passes and may be similar to the map derived at 516 of the technique 500 of FIG. 5. However, the map derived at 614 may accurately and distinctly identify each pass within the map as an in-field pass or a headland pass instead of simply a generic pass taken by the agricultural machine. Such identification of passes may be critical to effectively generate turns between the passes using techniques such as the ones described herein.

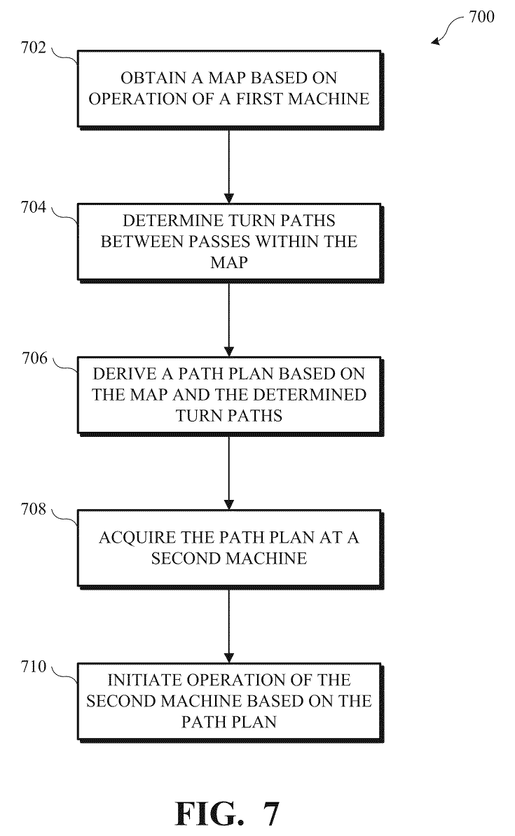

FIG. 7 is a flowchart of an example of a technique 700 for navigating a second machine (e.g., the second agricultural machine 204 of FIG. 2) according to a path plan derived from a map that is based on operation of a first agricultural machine (e.g., the first agricultural machine 202 of FIG. 2). For example, the first agricultural machine may initially traverse a field along a travel path so that a map of the travel path may be derived. As discussed above, the map may include and/or identify in-field passes and headland passes along the travel path. A path plan may then be derived so that the second agricultural machine may subsequently traverse the field according to the set path plan.

The technique 700 can be executed using computing devices, such as the systems, hardware, and software described with respect to FIGS. 1A-4. The technique 700 can be performed, for example, by executing by a machine-readable program or other computer-executable instructions, such as routines, instructions, programs, or other code. The steps, or operations, of the technique 700, or another technique, method, process, or algorithm described in connection with the implementations disclosed herein, can be implemented directly in hardware, firmware, software executed by hardware, circuitry, or a combination thereof. The technique 700 can be executed by a path planning software, such as the path planning software 210 or the path planning software 214 of FIG. 2. The technique 700 can additionally, or alternatively, be executed by a remote configuration system, such as the remote configuration system 218 of FIG. 2.

For simplicity of explanation, the technique 700 is depicted and described herein as a respective series of steps or operations. However, the steps or operations of the technique 700 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

A map based on the operation of the first agricultural machine may be obtained by the first agricultural machine at 702. In an example, the first agricultural machine may complete an initial traversal of the field along a travel path. During such traversal, a position (e.g., a GPS position) of the first agricultural machine may be tracked and recorded using the techniques described above, such as the technique 500 and/or the technique 600. The recorded position(s) may then be used to derive a map. For example, as discussed above, the recorded position(s) may be recorded as in-field or headland positions to identify headland passes and in-field passes. A map may then be derived based on the identified passes and subsequently obtained at 702 (e.g., obtained by the path planning software of the first agricultural machine or obtained by a remote configuration system in communication with the first agricultural machine).

Once the map is obtained, the technique 700 may determine turn paths between the identified passes within the map. For example, the technique 700 may determine and optimize turn paths between in-field passes, between headland passes, between in-field passes and headland passes, or a combination thereof, such as the turn paths 336A, 336B of FIG. 3B. As discussed above, the turn paths may be generated to effectively and accurately connect in-field passes to one another and/or headland passes to one another to optimize a path plan for subsequent traversal of the field. By identifying the headland passes and the in-field passes, the path plan may effectively connect passes and avoid unnecessary turns or overlapping passes, which may ultimately damage the crop located within the in-field.

Once the path plan is derived, the second agricultural machine may acquire the path plan from the first agricultural machine at 708. For example, a path planning software of the second agricultural machine may acquire the path plan from the path planning software of the first agricultural machine or from the remote configuration system. After acquiring the path plan, the second agricultural machine may initiate operation based on the path plan at 710. That is, the second agricultural machine may traverse the field based on the derived path plan to substantially follow the path plan. In an example, the second agricultural machine may include a GPS unit (e.g., a GPS receiver) so that the GPS location of the second agricultural machine may be tracked. As such, a guidance system of the second agricultural machine may monitor the location of the second agricultural machine to guide the second agricultural machine along the path defined by the path plan to ensure that the second agricultural machine does not inadvertently deviate from the path defined by the path plan.

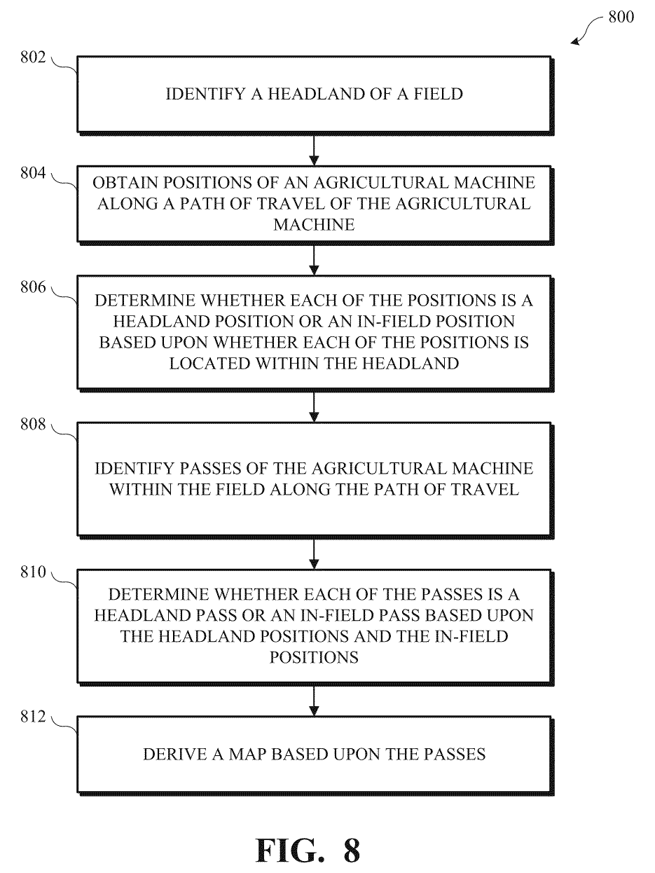

FIG. 8 is a flowchart of another example of a technique 800 for deriving a map based on a position of an agricultural machine (e.g., the agricultural machine 302 of FIGS. 3A and 3B). The map may include a representation of the path traveled by the agricultural machine. The technique 800 can be executed using computing devices, such as the systems, hardware, and software described with respect to FIGS. 1A-4. The technique 800 can be performed, for example, by executing by a machine-readable program or other computer-executable instructions, such as routines, instructions, programs, or other code. The steps, or operations, of the technique 800, or another technique, method, process, or algorithm described in connection with the implementations disclosed herein, can be implemented directly in hardware, firmware, software executed by hardware, circuitry, or a combination thereof. The technique 800 can be executed by a path planning software, such as the path planning software 210 or the path planning software 214 of FIG. 2. The technique 800 can additionally, or alternatively, be executed by a remote configuration system, such as the remote configuration system 218 of FIG. 2.

For simplicity of explanation, the technique 800 is depicted and described herein as a respective series of steps or operations. However, the steps or operations of the technique 500 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

A headland of a field may be identified at 802. The headland of the field may be identified based upon user input or may be obtained via communication with an external device. For example, the user may manually input (e.g., via the user interface 406 of FIG. 4) an in-field perimeter and an outer perimeter of the field so that the technique 800 may identify a region between the in-field perimeter and the outer perimeter as the headland. Using the field 304 shown in FIGS. 3A and 3B as an example, the user may manually input the in-field perimeter 314 and the outer perimeter 320 such that the path planning software may determine that the region located therebetween is the headland 316.

After identifying the headland, positions of the agricultural machine along a travel path of the agricultural machine may be obtained at 804. For example, technique 800 may obtain positions of the agricultural machine along the travel path based upon a guidance system of the agricultural machine tracking the position of the agricultural machine. In an example, the guidance system may be or may include a GPS unit, which may track a GPS position of the agricultural machine along the travel path of the agricultural machine and transmit such GPS positions to the path planning software.

Once the positions are obtained, it may be determined whether each of the obtained positions is a headland position or an in-field position based upon whether each of the positions is located within the identified headland at 806. For example, it may be determined whether each of the obtained positions is a headland position or in-field position using the techniques described above with respect to the operations 508-512 of the technique 500. By way of example, the obtained positions may be evaluated by the technique 800 to determine if the obtained positions are located within the identified headland, located within the in-field (e.g., the in-field at least partially surrounded by the headland), or located outside of the field (e.g., outside of an outer perimeter of the field).

After determining whether each of the positions of the agricultural vehicle is a headland position or an in-field position, passes of the agricultural vehicle within the field (e.g., within the outer perimeter of the field) along the travel path may be identified at 808. For example, the passes may be identified based on the techniques 500, 600, 700 of FIGS. 5-7 described above. By way of example, the passes may correspond to discrete segments of the travel path of the agricultural, where such discrete segments may be determined based upon initiating and stopping or pausing recording the position of the agricultural machine. For example, each discrete segment along the travel path may be based on a data set of data points, where each data point may correspond to a particular position (e.g., GPS position) of the agricultural machine. The data set may correspond to a particular recording (i.e., to a particular iteration of recording from initiating recording to pausing or stopping the recording). As such, the technique 800 may discern one recording from another recording (i.e., discern one data set of obtained GPS positions of the agricultural machine from another data set of obtained GPS positions of the agricultural machine) to thereby identify the unique passes along the travel path of the agricultural machine.

Once the passes are identified, it may be determined at 810 whether each of the passes is a headland pass or an in-field pass based upon the headland positions and the in-field positions. The passes may be determined to be a headland pass or an in-field pass using the techniques described above with respect to operations 606-612 of the technique 600 of FIG. 6. In an example, the technique 800 may determine the number of headland positions determined at 806 for a particular pass identified at 808 and compare the number of headland positions to the total number of obtained positions for that particular pass. As such, the technique 800 may determine what percentage of the total number of obtained position for the particular pass are headland positions. The percentage may then be compared to a predefined threshold (e.g., a predefined percentage) to determine whether the particular pass is a headland pass or an in-field pass.

Once the headland passes and the in-field passes are determined at 810, a map based upon the passes may be derived at 812. The map may be derived using the techniques 500, 600, 700 of FIGS. 5-7 described above. In an example, the map may be derived to identify each of the passes as an in-field pass or a headland pass and map the passes relative to one another within the field. The passes may also be mapped relative to the outer perimeter of the field, the in-field perimeter, the headland, the in-field, or a combination thereof to provide an accurate portrayal of the travel path of the agricultural machine. Based on the derived map, a path plan may be determined and set for subsequent operations of the agricultural machine or another agricultural machine (e.g., a second agricultural machine). As discussed above, the path plan may include generating turn paths between identified passes to optimize the travel path for subsequent operations of the agricultural machine or the other agricultural machine (e.g., the second agricultural machine).

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180° ± 25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A method, comprising:
obtaining positions of an agricultural machine along a path of travel of the agricultural machine within a field;
determining whether each of the positions is a headland position or an in-field position based on whether each of the positions is located within a headland of the field;
identifying passes of the agricultural machine within the field along the path of travel;
determining whether each of the passes is a headland pass or an in-field pass based upon the headland positions and the in-field positions; and
deriving a map based upon the passes, wherein the map includes the passes and each of the passes is identified as a headland pass or an in-field pass.

2. The method of claim 1, wherein a position is determined to be a headland position if the position is located within the headland.

3. The method of claim 2, wherein a position is determined to be an in-field position if the position is located outside of the headland and is within an in-field region located adjacent to the headland.

4. The method of claim 1, wherein identifying the headland of the field comprises:
defining a perimeter of the field; and
defining a perimeter of an in-field region within the field, wherein the headland is an area located between the perimeter of the field and the perimeter of the in-field region.

5. The method of claim 1, wherein determining whether each of the passes is a headland pass or an in-field pass comprises:
comparing a number of headland positions in each of the passes to a threshold, wherein each of the passes is determined to be a headland pass if the number of the headland positions exceeds the threshold.

6. The method of claim 1, wherein the positions are obtained based upon a first agricultural machine traversing the path of travel, and wherein the method further comprises:
deriving a path plan for a second agricultural machine based on the map.

7. The method of claim 6, wherein the method further includes:
determining turn paths between the passes, wherein the path plan is based on the map and the turn paths.

8. The method of claim 1, wherein the agricultural machine includes an implement, and wherein identifying the passes is based upon determining when the implement is operating.

9. The method of claim 8, wherein the identified passes correspond to discrete portions of the path of travel that are traversed by the agricultural machine when the implement is operating, and wherein the identified passes are separated by discrete portions of the path of travel that are traversed by the agricultural machine when the implement is not operating.

10. A system, comprising:
one or more memories; and
one or more processors, the one or more processors configured to execute instructions stored in the one or more memories to:
obtain positions of an agricultural machine along a path of travel of the agricultural machine within a field;
determine whether each of the positions is a headland position or an in-field position based on whether each of the positions is located within a headland of the field;
identify passes of the agricultural machine within the field along the path of travel;
determine whether each of the passes is a headland pass or an in-field pass based upon the headland positions and the in-field positions; and
derive a map based upon the passes, wherein the map includes the passes and each of the passes is identified as a headland pass or an in-field pass.

11. The system of claim 10, wherein a position is determined to be a headland position if the position is located within the headland and the position is determined to be an in-field position if the position is located outside of the headland and within an in-field region, the in-field region being located adjacent to the headland.

12. The system of claim 10, wherein the instructions to identify a headland of the field include instructions to:
define a perimeter of the field; and
define a perimeter of an in-field region within the field, wherein the headland is an area located between the perimeter of the field and the perimeter of the in-field region.

13. The system of claim 10, wherein the instructions to determine whether each of the passes is a headland pass or an in-field pass include instructions to:
compare a number of headland positions in each of the passes to a threshold, wherein each of the passes is determined to be a headland pass if the number of headland positions exceeds the threshold.

14. The system of claim 10, wherein the positions are obtained based upon a first agricultural machine traversing the path of travel, and wherein the one or more processors are further configured to execute instructions stored in the one or more memories to:
derive a path plan for a second agricultural machine based on the map.

15. The system of claim 14, wherein the one or more processors are further configured to execute instructions stored in the one or more memories to:
determine turn paths between the passes, wherein the path plan is based on the map and the turn paths.

16. The system of claim 10, wherein the agricultural machine includes an implement, and wherein the passes are identified based upon determining when the implement is operating.

17. The system of claim 16, wherein the identified passes correspond to discrete portions of the path of travel that are traversed by the agricultural machine when the implement is operating, and wherein the identified passes are separated by discrete portions of the path of the path of travel that are traversed by the agricultural machine when the implement is not operating.

18. One or more non-transitory computer readable media storing instructions operable to cause one or more processors to perform operations, comprising:
obtaining positions of an agricultural machine along a path of travel of the agricultural machine within a field;
determining whether each of the positions is a headland position or an in-field position based on whether each of the positions is located within a headland of the field;
identifying passes of the agricultural machine within the field along the path of travel;
determining whether each of the passes is a headland pass or an in-field pass based upon the headland positions and the in-field positions; and
deriving a map based upon the passes, wherein the map includes the passes and each of the passes is identified as a headland pass or an in-field pass.

19. The one or more non-transitory computer readable media of claim 18, wherein a position is determined to be a headland position if the position is located within the headland and the position is determined to be an in-field position if the position is located outside of the headland and within an in-field region, the in-field region being located adjacent to the headland.

20. The one or more non-transitory computer readable media of claim 18, wherein determining whether each of the passes is a headland pass or an in-field pass comprises:
comparing a number of headland positions in each of the passes to a threshold, wherein the each of the passes is determined to be a headland pass if the number of headland positions exceeds the threshold.
